(19) United States
(12) Patent Application Publication
(10) Pub. No.: US 2009/0228482 A1
(43) Pub. Date: Sep. 10, 2009

(54) NETWORK SEARCH METHOD, SYSTEM AND DEVICE

(75) Inventor: Fujun YE, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/463,064

(22) Filed: May 8, 2009

Related U.S. Application Data
(63) Continuation of application No. PCT/CN2007/070577, filed on Aug. 28, 2007.

(30) Foreign Application Priority Data
Nov. 9, 2006 (CN) 200610138354.8,

(51) Int. Cl. G06F 17/30

(52) U.S. Cl. 707/5; 707/E17.108; 707/102; 707/E17.005; 707/E17.044; 707/200

(57) ABSTRACT

The disclosure provides a network search method, including the following steps at the network side: obtaining a search sentence sent from a user terminal; processing keywords for the search sentence according to an individual search profile and a shared search profile; searching in accordance with the keywords to obtain search results; and sorting and displaying the search results. With the invention, through information sharing among users and providing feedback for the search results browsed by the user, the individual search profile and the shared search profile may be improved constantly, and the user's search sentence may be enriched and improved according to the individual search profile and the shared search profile. In this manner, the accuracy and coverage for the search may be improved, and hence the user's search requirements may be better satisfied.

### CROSS REFERENCE

This application is a continuation of International Application No. PCT/CN2007/070577, filed on Aug. 28, 2007, titled “NETWORK SEARCH METHOD, SYSTEM AND DEVICE”, which claims the priority of CN application No. 200610138354.8, filed on Nov. 9, 2006, titled “NETWORK SEARCH METHOD, SYSTEM AND DEVICE”, the entirety of which is incorporated herein by reference.

### FIELD OF THE INVENTION

The invention relates to the field of network information search, and more particularly, to a network search method, system and device.

### BACKGROUND

The invention relates to the field of network information search, and more particularly, to an improved search method which may enhance the accuracy and the coverage in accordance with a search profile.

U.S. Pat. No. 7,031,961 issued to Google, entitled “System and Method for Searching and Recommending Objects from a Categorically Organized Information Repository” relates to a search technique. According to the disclosure of the patent, a search sentence of a user may be extended according to the individual context information of the user or the context information shared by a group of users, so as to improve the accuracy for the search. In the patent, an individual user profile and a group user profile are included. A profile is established by deriving an array of keywords from a set of documents corresponding to all bookmarks (each bookmark is an address directed to a certain content) under a certain topic saved by the user, that is, keywords are extracted from documents under all different topics to be used as the individual user profile or the group user profile. A group is established on the basis of the same bookmarks maintained for the users, each group being a topic. Context information is the title and the directory of a bookmark, and the user profile as well. With this method, the search accuracy may be enhanced to some extent, but the search coverage cannot be improved. First, the content in the address corresponding to the bookmark may vary often and thus information may become highly unrelated. Second, the bookmark directory is established manually in the patent and cannot be updated by itself, which renders the context information very limited, and hence the search coverage is limited.

### SUMMARY

Embodiments of the invention provide a method, system, device and user terminal for network search so that search results may be provided to the user as desired according to different topic categorizations.

A network search method includes:

obtaining a search sentence from a user, extracting keywords from the search sentence, and establishing a directory for the keywords in accordance with a pre-established search profile;

searching in accordance with contents of the directory for the keywords, to obtain search results; and

providing the search results to the user according to the directory for the keywords.

A network search system includes a network search device and a user device.

The network search device is configured to obtain a search sentence sent from the user device, to extract keywords from the search sentence, to establish a directory for the keywords in accordance with a search profile, to search in accordance with the directory for the keywords so as to obtain search results, and to provide the search results to the user device in accordance with the directory for the keywords.

The user device is configured to send the search sentence to the network search device and to receive the search results provided from the network search device.

A network search device includes a network interaction unit, a processing unit and a search profile storage unit.

The network interaction unit is configured to receive a search sentence and send the search sentence to the processing unit, and to receive search results provided from the processing unit and send the search results.

The processing unit is configured to receive the search sentence sent from the network interaction unit, to extract keywords from the search sentence, to establish a directory for the keywords in accordance with a search profile stored in the search profile storage unit, to search in accordance with contents of the directory for the keywords so as to obtain the search results, and to provide the search results to the network interaction unit.

The search profile storage unit is configured to store the search profile.

A user device includes an I/O unit, a user interaction unit and a terminal data storage unit.

The I/O unit is configured to obtain a search sentence input by a user, to send the search sentence to the user interaction unit, and to display search results provided by the user interaction unit to the user.

The user interaction unit is configured to send the search sentence from the I/O unit to a network search device, to receive the search results from the network search device, to provide the search results to the I/O unit, and to provide the user's browse information stored in the terminal data storage unit to the network search device.

The terminal data storage unit is configured to store the user's browse information.

It can be seen from the above technical solutions that, with the method, system and device provided in embodiments of the invention, a directory for keywords is established, a search is made according to the directory for the keywords, and the search results are provided to the user according to the directory for the keywords. In this manner, the search results desired by the user are arranged by categorizing different topics according to the contents of the directory for the keywords, as compared with the prior arts in which the topics of all search results are mixed together. Therefore, with the method, system and device provided in embodiments of the invention, the search results desired by the user may be categorized according to different topics and provided so that the presentation of the search results is more straightforward and intelligible.

### BRIEF DESCRIPTION OF THE DRAWINGS

FIG. 1 is a flow chart showing a network search method according to a first embodiment of the invention;

FIG. 2 is a flow chart showing how the network side processes the search sentence according to a first embodiment of the invention;

FIG. 3 is a flow chart showing how the network side searches in accordance with the processed content according to a first embodiment of the invention;

FIG. 4A is a diagram showing a directory obtained by processing the search sentence at the network side according to a first embodiment of the invention;

FIG. 4B is a diagram showing a synonym repository and an attribute repository according to a first embodiment of the invention;

FIG. 5 is a flow chart showing how the individual attribute repository is updated according to a first embodiment of the invention;

FIG. 6 is a flow chart showing how the shared attribute repository is updated according to a first embodiment of the invention;

FIG. 7A and FIG. 7B are diagrams showing the structure of the directory for an attribute repository according to a first embodiment of the invention;

FIG. 8A and FIG. 8B are diagrams showing the structure of the directory for another attribute repository according to a first embodiment of the invention;

FIG. 9A and FIG. 9B are diagrams showing the structure of the directory for still another attribute repository according to a first embodiment of the invention;

FIG. 10 is a block diagram showing the configuration of a network search device and a user terminal according to a second embodiment of the invention;

FIG. 11 is a block diagram showing the configuration of a network search device and a user terminal according to a third embodiment of the invention;

FIG. 12 is a flow chart showing how a search is made in accordance with the contents of the directory for the keywords according to an embodiment of the invention;

FIG. 13 is a flow chart showing how the individual attribute repository is updated according to an embodiment of the invention; and

FIG. 14 is a block diagram showing the configuration of a network search system according to an embodiment of the invention.

### DETAILED DESCRIPTION

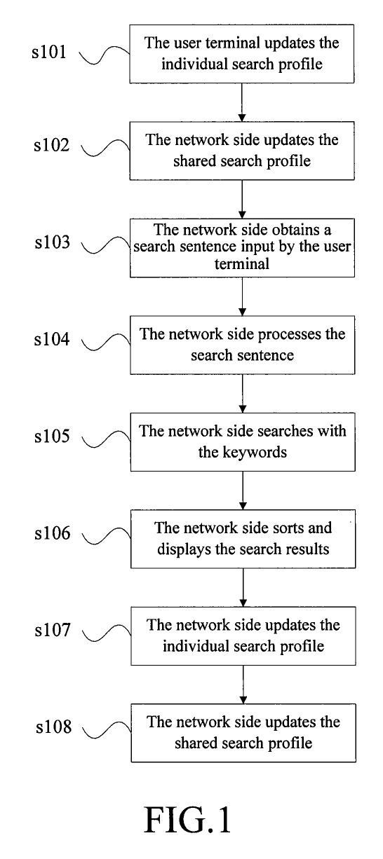

In the first embodiment of the invention, a network search method is shown in FIG. 1, including the following steps.

In step s101, the user terminal updates the individual search profile.

The individual search profile may include an individual synonym repository and an individual attribute repository. First, a user obtains a personal account via registration. After logging with his personal account, the user may add a desired keyword to his individual synonym repository and then input synonyms for the keyword. In this way, the user's individual synonym repository may be obtained. Additionally, when the user adds a synonym, the system may recommend the synonyms used by other users in the system-shared synonym repository to the user. The user may select to add the synonyms or reject addition of the synonyms. Finally, the system may also recommend the synonyms in the dictionary to the user, and the user may select to add the synonyms or reject addition of the synonyms. In the above manners, the user may establish his individual synonym repository at the first use and extend the repository constantly in the future.

The user's individual attribute repository includes a directory and the attributes of the directory, and is empty at the first use. The system may extend the user's individual attribute repository constantly during the user's search process, and the user may also edit his individual attribute repository.

The structure of the directory of the attribute repository may be established in four manners. (1) The structure of the directory may be established according to the titles and the network addresses of the returned search results, as well as the contents. (2) A reference may be made to the structure of the directory at some websites whose categorizations are relatively mature, such as Yahoo, Sohu, etc. (3) The user may establish the structure of the directory. (4) The structure of the directory may be established according to the titles and the network addresses of the search results, and a branch directory may be added and/or branch directories may be combined and/or a branch directory may be deleted for the directory as required.

In step s102, the network side updates the shared search profile according to the individual search profiles.

The shared search profile may include a shared synonym repository and a shared attribute repository.

The network side may organize and consolidate the individual synonym repositories of all users, to obtain a consolidated synonym repository, that is, the shared synonym repository. Furthermore, the network side may add the synonyms found in a dictionary to the shared synonym repository. In accordance with the shared synonym repository, the network side may recommend synonyms to an individual user so as to update the user's individual synonym repository.

The shared attribute repository may include a directory and the attributes of the directory, and is empty at the first use. The system may extend the individual attribute repository constantly during the user's search process. The structure of the directory may be established in a manner the same as that of the individual attribute repository, detailed description of which is omitted here.

In step s103, the user terminal inputs a search sentence.

In step s104, the network side processes the search sentence according to the individual search profile and the shared search profile, so as to obtain some keywords.

In step s105, the network side searches by using the keywords.

In step s106, the network side sorts and displays the search results.

In step s107, the network side updates the individual search profile.

In step s108, the network side updates the shared search profile.

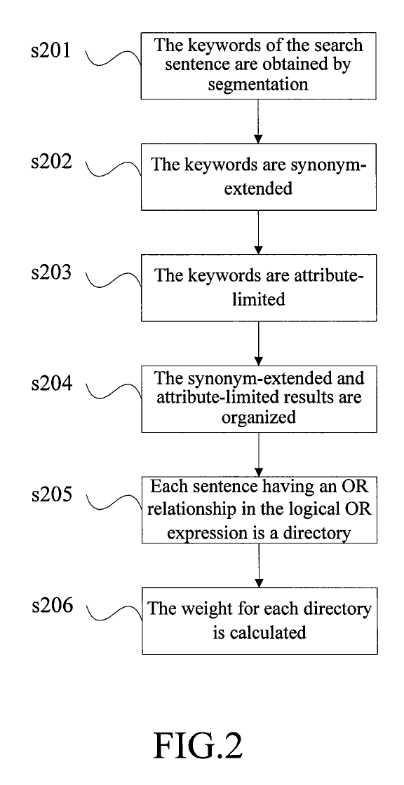

In step s104, the network side processes the search sentence as shown in FIG. 2, including the following steps.

In step s201, the search sentence is segmented, to obtain the keywords for the search sentence.

In step s202, the keywords are synonym-extended.

Synonym extension refers to represent the keywords in a logical OR expression. For example, if a keyword is X and X has synonyms such as X¹, X², . . . , and Xⁿ, the keyword may be extended to (X¹ or X² or . . . or Xⁿ). Each synonym has a respective weight to indicate the frequency at which the synonym is selected.

In step s203, the keywords are attribute-limited.

Attribute limitation refers to limiting a keyword with the attributes of the keyword in a logical AND expression. For example, if the attributes of X¹ are C¹¹, C¹², . . . , C^{1k}, the attributes of X² are C²¹, C²², . . . , C^{2k}, . . . , and the attributes of Xⁿ are Cⁿ¹, Cⁿ², . . . , C^{nk}, the keyword may be limited as ((X¹ and C¹¹ and C¹² and . . . and C^{1k}) or (X² and C²¹ and C²² and . . . and C^{2k}) or . . . or (Xⁿ and Cⁿ¹ and Cⁿ² and . . . and C^{nk})).

In step s204, the synonym-extended and attribute-limited keywords are organized, and are represented in a logical OR expression.

In step s205, each sentence having an OR relationship is regarded as a directory.

In step s206, the weight for each directory is calculated according to the content of the directory.

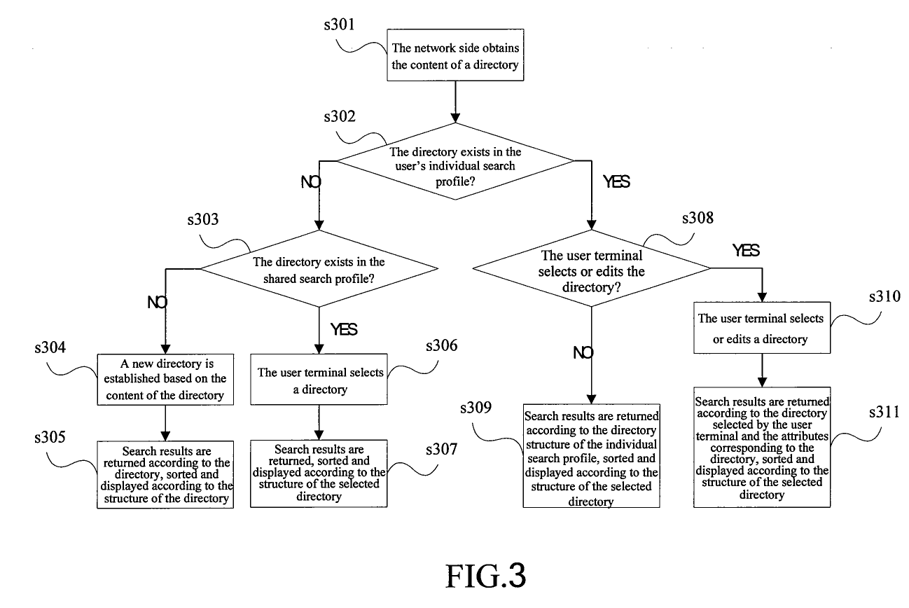

After the network side obtains multiple directories by processing the keywords of the search sentence in step s205, the content of each directory is searched in turn and the search results are sorted and displayed, as shown in FIG. 3, including the following steps.

In step s301, the network side obtains the content of a directory.

In step s302, the network side determines whether the content of the directory exists in the user's individual search profile. The flow proceeds with step s303, if the content of the directory does not exist in the user's individual search profile; the flow proceeds with step s308, if the content of the directory exists in the user's individual search profile.

In step s303, the network side determines whether the content of the directory exists in the shared search profile. The flow proceeds with step s304, if the content of the directory does not exist in the shared search profile; the flow proceeds with step s306, if the content of the directory exists in the shared search profile.

In step s304, a new directory is established in the shared search profile in accordance with the content of the directory.

In step s305, search results are returned according to the content of the directory, and are sorted and displayed according to the structure of the directory. The flow ends here.

In step s306, when there are several directories containing the content of the directory, the user terminal selects one among them.

In step s307, search results are returned according to the directory selected by the user terminal and the attributes corresponding to the directory, and are sorted and displayed according to the structure of the selected directory. The flow ends here.

In step s308, the user terminal determines whether to select or edit the directory. The flow proceeds with step s309, if the directory is not to be selected or edited; the flow proceeds with step s310, if the directory is to be selected or edited.

In step s309, search results are returned according to the structure of the directory of the individual search profile at the user terminal, and are sorted and displayed according to the structure of the directory. The flow ends here.

In step s310, the user terminal selects or edits a directory.

In step s311, search results are returned according to the directory selected by the user terminal and the attributes corresponding to the directory, and are sorted and displayed according to the structure of the selected directory. The flow ends here.

In this step, if the user terminal searches the processed directory information with the old individual search profile, the search results are arranged according to the keywords and their synonyms and attributes, as well as the matching degree between the keywords and the web pages or services. If the content of the directory does not exist, a search is made in the shared search profile. If at least one keyword associated with the content of the directory had been searched once among the keywords in the shared search profile, the directory associated with the keyword is recommended to the user terminal. The user terminal may select the structure of the directory including the keyword, and sort and display the search results according to the choice of the user terminal. If no keyword is found, a new directory will be established in the shared search profile according to the content of the directory, and the search results are returned. In accordance with the first N titles and contents (for example, N=200), the directories for the keywords are categorized. Alternatively, the user terminal may modify the structure of the old directory by searching the directories in the shared search profile, selecting some directories and adding them to the individual search profile in the user terminal.

By combining step s104 and step s105, an embodiment may be obtained as follows, in which the network side processes the keywords of the search sentence and returns the search results.

In an example where the user terminal searches for a spicy restaurant, if no matching webpage is found, the search sentence is segmented into “spicy” and “restaurant”. “Spicy” is the attribute for some first-level directories such as restaurant, hotel or capsicum. Restaurant, hotel and capsicum as the directory names, are attributes in themselves. Restaurant and hotel are synonyms with each other.

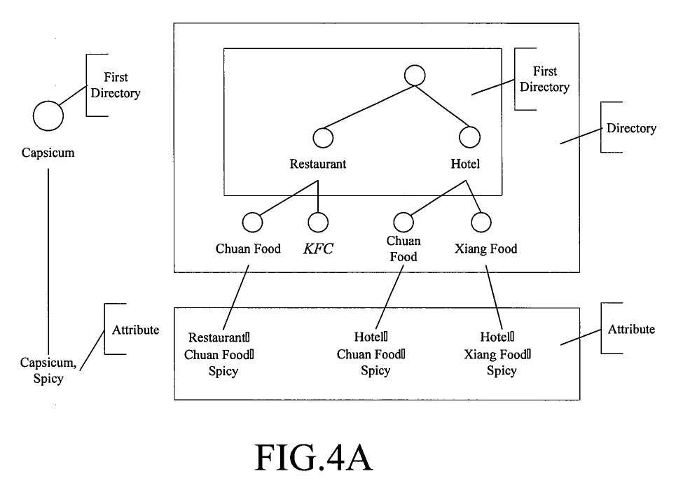

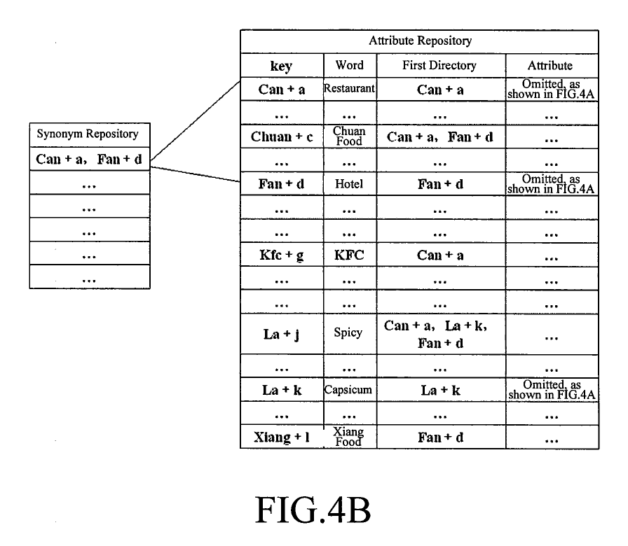

As shown in FIG. 4A, “spicy restaurant” is first synonym-extended to be spicy and (restaurant or hotel). Then, the first-level directories such as restaurant, hotel and spicy are attribute-limited. Different first-level directories are extended in the form of logical OR expression. In this way, the search sentence “spicy restaurant” may be segmented as (spicy and restaurant) or (spicy and hotel) or (spicy and capsicum)) and (restaurant or hotel) which may be used for search.

Here, there are six directories in total. If the sentence is converted to a logical OR form of A₁ or A₂ or . . . or Aₙ, it is given by:

(spicy and restaurant) or (spicy and restaurant and hotel) or (spicy and restaurant) or (spicy and hotel) or (spicy and capsicum and restaurant) or (spicy and capsicum and hotel).

After repeated portions are removed, it may be simplified as:

(spicy and restaurant) or (spicy and restaurant and hotel) or (spicy and hotel) or (spicy and capsicum and restaurant) or (spicy and capsicum and hotel).

In accordance with an attribute under a directory, the related directories may be found (∘ represents a directory node) as:

Restaurant→chuan food, hotel→chuan food, hotel→xiang food (3 related directories in total).

In accordance with the respective attributes of the three directories, i.e., (restaurant, chuan food, spicy), (hotel, chuan food, spicy), and (hotel, xiang food, spicy), and their respective weights as well as the content matching degree, the ranking order of the search results may be adjusted, and the search results may be displayed in three directories.

A storage configuration of the synonym repository and the attribute repository according to the invention is shown in FIG. 4B. Taking the restaurant in the attribute repository as an example, its ID is Can+a when being stored, in which a is the weight for restaurant, and “Can” is the Chinese word corresponding to “restaurant”. Restaurant, as the directory word for a first-level directory, is also an attribute in itself. Also taking chuan food as an example, its ID is Chuan+c when being stored, in which c is the weight for chuan food. The first-level directories in which chuan food resides, are restaurant (Can+a) and hotel (Fan+d). Meanwhile, restaurant (Can+a) and hotel (Fan+d) in the attribute repository are stored in the synonym repository as synonyms. Therefore, the synonym repository and the attribute repository in the invention may be extended on a layer-by-layer basis as shown in FIG. 4A and FIG. 4B.

In step s107, the network side updates the individual search profile of the user terminal in accordance with the browse records for the search results by the user terminal. The updating may include updating the individual synonym repository and updating the individual attribute repository.

Here, updating the individual attribute repository of the user may include the following cases.

1. Synonym deletion. If the occurrence frequency of a synonym is very low or zero, the network side prompts the user to delete the synonym. The rule is embodied in that a threshold is set for the occurrence frequency. If the occurrence frequency of a synonym is lower than the threshold, a prompt is made. There are many ways to set the threshold. For example, let t_{d}=fcₖ/n, where n is a positive number, fcₖ is the occurrence frequency of the k^{th} synonym cₖ in the synonym set among all synonyms in all the browsed documents containing the synonyms searched by the user when the user raises a query to a search engine, that is, the ratio of the occurrence number of the synonym to the occurrence number of all keywords,

$${fc}_{k} = {\sum }_{i , j} {δ}_{ck} ( {{Ω}_{ui} ( f )}_{j} ) / {\sum }_{i , j , k} {δ}_{ck} ( {{Ω}_{ui} ( f )}_{j} )$$

In this equation, ui represents the i^{th} user, Ωᵤᵢ(f)ⱼ represents the j^{th} document in a set of documents browsed by the user^{ui}. If the synonym cₖ occurs in the document, δ_{ck} is 1; if the synonym cₖ does not occur in the document, δ_{ck} is 0.

With this method, the occurrence numbers of all synonyms in the documents clicked and browsed by the user, have to be recorded per search. Alternatively, other methods may be used, for example, a synonym may be deleted according to the feedback from the user.

2. Synonym addition. Similar to the above method in which a threshold is set, a threshold may be set for a synonym having high occurrence frequency. If the search sentence or the returned result for a synonym has an occurrence frequency higher than the threshold, it indicates a high possibility that the keyword is useful to the user. The system may add this keyword to the user's individual synonym repository. The user may also add keywords to the synonym repository, or search the shared synonym repository to add synonyms.

The user's individual attribute repository may be updated via clustering. For example, with the clustering methods based on Distributed Hashing Table (DHT), Bayesian Network or Decision Tree, a directory may be established for a document and attributes may be established according to the documents under the directory. The specific steps for updating are as follows.

1. The content interesting to the user may be extracted according to the operation record for the search results by the user. The operation record may include clicking, and/or browsing, and/or saving, and/or copying, etc.

2. In accordance with the currently searched directory, each content file is mapped to the user's directory.

3. The network side system extracts keywords from the content into the repository, as the attribute of the searched directory.

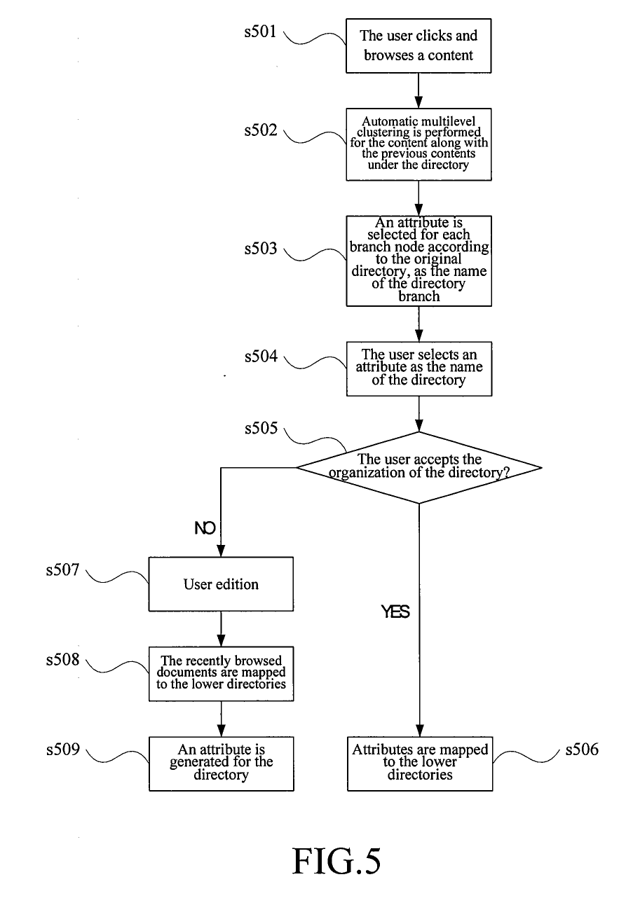

An embodiment for updating the individual attribute repository is as shown in FIG. 5, and includes the following steps.

In step s501, a document recently clicked by the user is recorded.

In step s502, automatic multilevel clustering is performed for the document and the previously clicked and browsed documents.

In step s503, an attribute is extracted for each branch node and used as the directory name. Here, minimum change is the principle and the old directory name should be used as much as possible.

In step s504, the user selects one from the automatically categorized attributes of a directory as the directory name.

In step s505, the user determines whether to accept the organization of the directory. If the determination is positive, the flow proceeds with step s506; if the determination is negative, the flow proceeds with step s507.

In step s506, all attributes are mapped to the bottom of the directory branch, and are regarded as the attributes of the directory branch, and the flow ends here. The categorization parameters among the attributes may be obtained by a categorization algorithm.

In step s507, the original structure of the directory is selected or the user may modify the directory.

In step s508, the recently browsed documents are mapped to the lower directory.

In step s509, the attributes may be extracted by using the categorization methods according to the documents under the directory, and the categorization parameters among the attributes may be obtained by the categorization algorithm.

In step s108, the network side may update the shared search profile according to the browse record for the search results by the user terminal. The update includes: updating the shared synonym repository and the shared attribute repository.

The shared synonym repository is updated in such a manner that the network side combines the individual synonym repositories of all user terminals so as to obtain an overall shared synonym repository at the network side. Alternatively, different user terminals are classified into different groups of user terminals according to the search preferences so that the shared synonym repository for each different group may be updated.

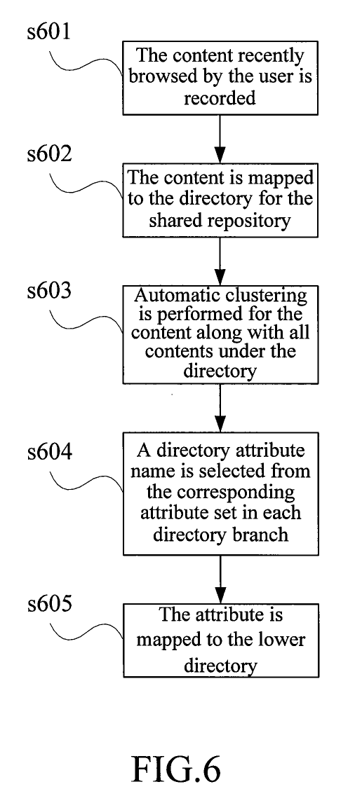

Updating the shared attribute repository is similar to updating the shared synonym repository. The embodiment for this step is as shown in FIG. 6, and includes the following steps.

In step s601, the content recently browsed by the user is recorded.

In step s602, the content is mapped to a directory of the attribute repository in the shared repository.

In step s603, automatic clustering is performed for all documents under the first-level directory of the directory to which the content belongs.

In step s604, a directory attribute name is selected from the corresponding attribute set in each directory branch.

In step s605, the attributes are mapped to the bottom. The attributes for each lower directory branch are all attributes for the directory branch.

For example, a user may want to get information about BMW and AUDI, as well as information about Volkswagen repairing, maintenance, insurance, etc (a specific model, a specific city, . . . ). In this way, there are different keywords: BMW, AUDI, and Volkswagen. The attributes for BMW and AUDI are news about recently developed models, and the attribute for Volkswagen is information about car repairing and maintenance.

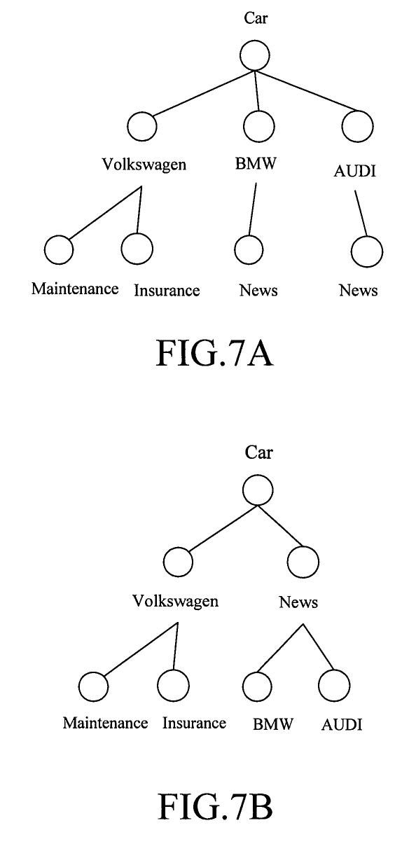

FIG. 7A shows the organization of the directory for the attribute repository in the example. The first-level directory may be car, below which are Volkswagen, BMW and AUDI. Below Volkswagen, there are maintenance and insurance. Below AUDI, there is news. Below BMW, there is news. After the user edition, as shown in FIG. 7B, Volkswagen and news are below car, whereas BMW and AUDI are below news. The structure of the directory will not produce a great influence on the search results because the clustering model is determined by the attributes, the directory word and the parameters under the directory (the influence may be non-linear). Under the lowest directory “BMW” at the right side of FIG. 7B, there may be attributes such as news, latest, popular, new, car, etc.

When a directory is to be created in the attribute repository, the name of the directory may be extracted from the titles of the search results of the user. Via the title, keywords may be sorted. In accordance with the maximum directory level limitation or word frequency limitation set by the user or set by the network side system, the number of attributes may be limited. By setting a threshold, all attributes whose occurrence frequency or weight is lower than the threshold may be discarded automatically.

For example, when the user inputs the search keyword BMW, the keywords in the titles of the results are as follows: car, 8 times; BMW, 4 times; others, for example, guide information once, blog once, owner party once. Because BMW and car occur in all contents, they may act as the first-level directory. If BMW is selected, BMW may act as the first-level directory. If BAOMA (Chinese word corresponding to BMW) exists in the synonym repository, it may be considered as a synonym; if BAOMA does not exist in the synonym repository, it is also taken as the keyword for a first-level directory. Other words, such as price, guide information, blog, or owner party, may be the second directories. All keywords form the attribute model. Here, a maximum directory level may be set for the directory.

For the individual attribute repository of the user, a webpage or document of interest to the user, or other information, may be obtained by recording the user's clicking and browsing of the search results. Then, the user's individual directory and the corresponding attributes may be generated. In this example, the first-level directory may be BMW, below which there is news.

If the user is not satisfied with the directory, edition may be performed. There might be a directory within which BMW is present, and the user may put this word in the synonym repository.

If the user searches the shared repository and obtains directories in the shared repository, the user selects the structures of some directories: news is below BAOMA, and BMW is taken as the synonym of BAOMA. After a certain time period (the update time for the synonym repository in the shared repository), BMW is delivered to the synonym repository in the shared repository. Since BMW is taken as the synonym of BAOMA, some documents related to BMW and BAOMA are mapped under BMW and BAOMA. The related directories and attributes may be established for BMW and BAOMA.

In accordance with the feedback for the search results browsed by the user and after self-updating, the initial directory is BMW below which there is news. If the user also searches for AUDI, when automatic clustering is performed, BMW and AUDI, as well as some attributes are generally below car (the most common keyword is car and news is also very common, but only one is selected with all keywords as the attributes) in accordance with the users browse condition.

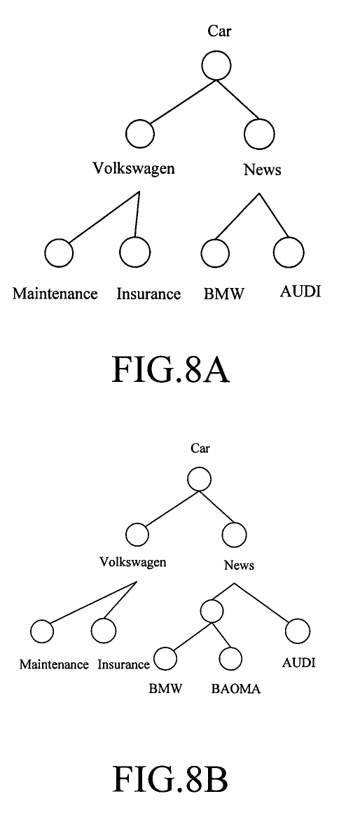

If the user also searches for Volkswagen and mainly focuses on maintenance and insurance for Volkswagen, the whole directory may be re-adjusted as shown in FIG. 8A. The branch of Volkswagen occurs below car, and below Volkswagen are maintenance and insurance.

As a synonym, BMW will belong to a branch same as BAOMA, as shown in FIG. 8B. Although being taken as a synonym in clustering, BMW is separated from the corresponding documents below, and a lower clustering directory is formed having its own specific documents and attributes, as well as corresponding weights.

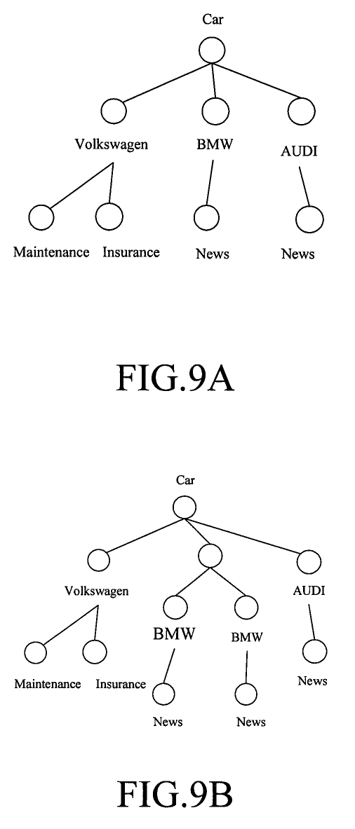

Another format of the directory is shown in FIG. 9A and FIG. 9B.

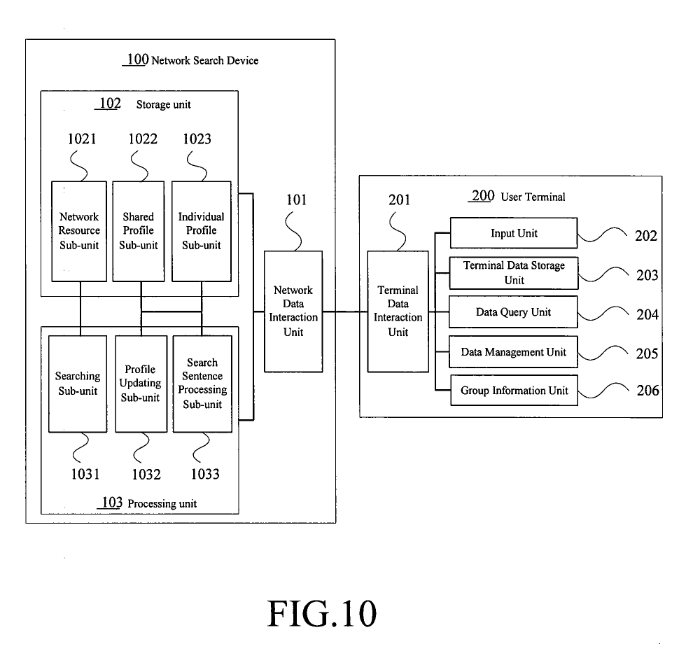

A network search device is provided in the second embodiment of the invention. As shown in FIG. 10, the network search device 100 includes a network data interaction unit 101, a storage unit 102 and a processing unit 103.

The network data interaction unit 101 is configured to exchange information between the network search device 100 and various user terminals.

The storage unit 102 is configured to store the individual search profile of each user terminal, the shared search profile of the network side and resources at the network side. The storage unit 102 may further include a network resource sub-unit 1021, a shared profile sub-unit 1022 and an individual profile sub-unit 1023.

The network resource sub-unit 1021 is configured to store all webpage resources at the network side.

The shared profile sub-unit 1022 is configured to store the repositories shared to the user terminal from the network side, including a shared synonym repository and a shared attribute repository. The shared profile sub-unit uses the same shared content for different user terminals, or uses the contents shared by a different group of user terminals for a different user terminal.

The individual profile sub-unit 1023 is configured to store the registration information of each user terminal and the repository of the user terminal, the repository including an individual synonym repository and an individual attribute repository.

The processing unit 103 is configured to process a search command received from the user terminal and send the search results. The processing unit 103 may further include a searching sub-unit 1031, a profile updating sub-unit 1032 and a search sentence processing sub-unit 1033.

The search sentence processing sub-unit 1033 is configured to process a search sentence received from the user terminal. A specific example is as follows.

(1) Upon receiving the logging information of the user terminal (UserID, Password), the user terminal performs identify authorization, and correct or false information is returned, which may be represented in Boolean.

(2) After the search sentence from the user terminal (UserID, the search sentence) is received, the search sentence is improved and enriched according to the contents saved in the shared profile sub-unit 1022 and the individual profile sub-unit 1023. The relative processes include segmentation, synonym-extension and attribute-limitation.

(3) After a function of querying the search profile by the user (UserID, keywords, IndividualProfile) or (UserID, keywords, SharedProfile), a related directory (UserID, the directory structure) is returned in response to the user's request, and the search sentence is extended with attributes in accordance with the user's selection and edition of the directory and the related attribute model (UserID, Revised directory structure and the attribute model).

The profile updating sub-unit 1032 is configured to update the shared profile sub-unit 1022 and the individual profile sub-unit 1023 according to the clicking and browsing of the search results by the user terminal. The updating includes addition, modification, combination and deletion of a synonym in the synonym repository, and addition, modification, combination and deletion of a directory and an attribute in the attribute repository.

The searching sub-unit 1033 is configured to search according to the processed search command, to sort and send the search results to the user terminal.

A user terminal for network search is also provided in the second embodiment of the invention. As shown in FIG. 10, the user terminal 200 includes a terminal data interaction unit 201, an input unit 202, a terminal data storage unit 203, a data query unit 204, a data management unit 205 and a group information unit 206.

The terminal data interaction unit 201 is configured to exchange information between the user terminal and the network side.

The input unit 202 is configured to perform various operations of the user terminal. The user terminal logs in, sends the search sentence and browses the search results via the unit.

The terminal data storage unit 203 is configured to store various operations for the search results by the user terminal, as well as the network addresses of the web pages, documents, audio and/or video browsed by the user terminal.

The data query unit 204 is configured to query the individual search profile and the shared search profile stored at the network side.

The data management unit 205 is configured to modify the individual search profile and the directory stored at the network side.

The group information unit 206 is configured to manage information about a user terminal group to which the user terminal belongs. The user terminal may control whether to join or leave the user terminal group, and select a shared directory and a document. Alternatively, it may be controlled by the network side according to the user's search record and browse record via automatic clustering.

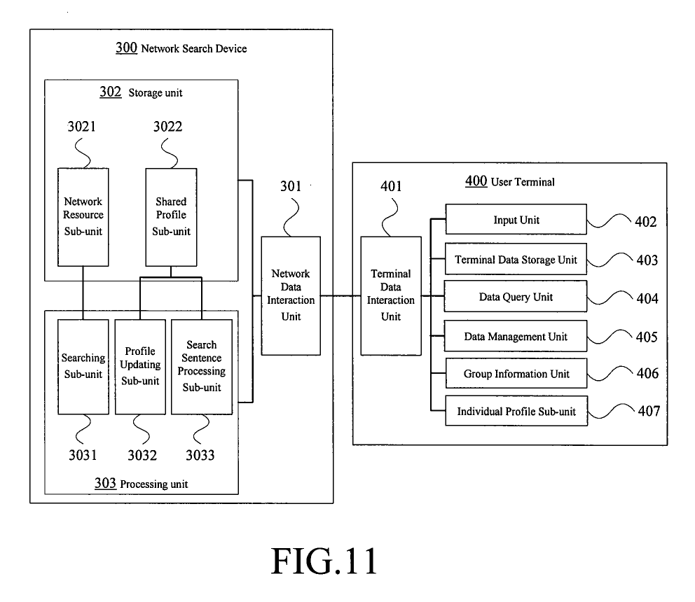

Another network search device is provided in the third embodiment of the invention. As shown in FIG. 11, the network search device 300 includes a network data interaction unit 301, a storage unit 302 and a processing unit 303.

The network data interaction unit 301 is configured to exchange information between the network search device 300 and each user terminal.

The storage unit 302 is configured to store the shared search profile at the network side and resources at the network side. The storage unit 302 may further include a network resource sub-unit 3021 and a shared profile sub-unit 3022.

The network resource sub-unit 3021 is configured to store all webpage resources at the network side.

The shared profile sub-unit 3022 is configured to store a repository at the network side shared to user terminals, including a shared synonym repository and a shared attribute repository. The shared profile sub-unit uses the same shared content for different user terminals, or uses the contents shared by a different group of user terminals for a different user terminal.

The processing unit 303 is configured to process a search command received from the user terminal and to send the search results. The processing unit 303 may further include a searching sub-unit 3031, a profile updating sub-unit 3032 and a search sentence processing sub-unit 3033.

The search sentence processing sub-unit 3033 is configured to process the search sentence received from the user terminal in accordance with the contents stored in the shared profile sub-unit 3022 and the user terminal' individual profile obtained from the user terminal. The specific process is the same as in the second embodiment, and detailed description is omitted here.

The profile updating sub-unit 3032 is configured to update the shared profile sub-unit 3022 in accordance with the clicking and browsing of the search results by the user terminal. The update includes addition, modification, combination and deletion of a synonym in the synonym repository, and addition, modification, combination and deletion of a directory and an attribute in the attribute repository.

The searching sub-unit 3031 is configured to search according to the processed search command, and to sort and send the search results to the user terminal.

Another user terminal for network search is also provided in the third embodiment of the invention. As shown in FIG. 11, the user terminal 400 includes a terminal data interaction unit 401, an input unit 402, a terminal data storage unit 403, a data query unit 404, a data management unit 405, a group information unit 406 and an individual profile sub-unit 407.

The terminal data interaction unit 401 is configured to exchange information between the user terminal and the network side.

The input unit 402 is configured to perform various operations of the user terminal. The user terminal logs in, sends the search sentence and browses the search results via the unit.

The terminal data storage unit 403 is configured to store various operations for the search results by the user terminal, as well as the network addresses of the web pages, documents, audio and/or video browsed by the user terminal.

The data query unit 404 is configured to query the shared search profile stored at the network side.

The data management unit 405 is configured to manage the contents and the directories locally stored in the individual search profile, including addition, modification, combination and deletion of a synonym in the synonym repository, and addition, modification, combination and deletion of a directory and an attribute in the attribute repository.

The group information unit 406 is configured to manage information about a user terminal group to which the user terminal belongs. The user terminal may control whether to join or leave the user terminal group, and select a shared directory and a document. Alternatively, it may be controlled by the network side according to the user's search record and browse record via automatic clustering.

The individual profile sub-unit 407 is configured to store the registration information of each user terminal and the repository for the individual search profile of the user terminal. The repository includes an individual synonym repository and an individual attribute repository.

The network search method provided in an embodiment of the invention mainly includes: obtaining a search sentence from a user, extracting keywords from the search sentence, and establishing a directory for the keywords in accordance with a search profile; searching in accordance with contents of the directory for the keywords, to obtain search results; and providing the search results to the user according to the directory for the keywords.

Here, establishment of the directory for the keywords refers to performing a synonym extension and an attribute limitation on the keywords of the search sentence. In other words, the synonyms and the attributes are added for the keywords, and the structure of a directory is formed with the keywords, the synonyms and the attributes of the keywords, to obtain the directory for the keywords.

Before the step s101 shown in FIG. 1, a further step may be included, in which the user terminal establishes an individual search profile.

If the method is used for network search for the first time, a search profile is to be established. The search profile may include an individual search profile, which in turn includes an individual synonym repository and an individual attribute repository.

The individual synonym repository may be established as follows. A user device may add a desired keyword to its individual synonym repository, and then input the synonyms of the keyword, to obtain the user's individual synonym repository. For example, if a user wants to make a search with respect to BAOMA, he may input “BAOMA” to his individual synonym repository, and then add its synonym “BMW”. Additionally, when the synonym is added, the system may recommend synonyms used by other users in the system-shared synonym repository to the user. The user may select to add the synonyms or reject the addition. A dictionary may be provided inside the system. When the user adds a keyword via the user device, the system may recommend the synonyms in the dictionary to the user, and the user may select to add the synonyms or reject the addition. With the above methods, the user may establish his individual synonym repository at the first use.

If the initial search is not performed with this method, step s101 may be performed.

The individual attribute repository is constituted in form of directory. A node of a directory is an attribute and is empty at the first use. In the user's search process, the system may extend the individual attribute repository of the user constantly and the user may also edit the individual attribute repository.

If there is no shared search profile yet before step s102 shown in FIG. 1, a shared search profile needs to be established.

Furthermore, the search profile may include an individual search profile only or a shared search profile only.

The processing on the keyword in step s104 is as follows: the network side extracts keywords from the search sentence, and establishes a directory for the keywords in accordance with the individual search profile and the shared search profile.

Establishment of the directory for the keywords in accordance with the search profile includes: extending the keywords with the synonyms of the keywords in the search profile, and limiting the keywords with the attributes of the keywords in the search profile.

Specifically, the step s203 shown in FIG. 2 further includes: performing attribute limitation on the synonym-extended keywords.

At this step, if the synonym-extended keywords have a matching directory in the attribute repository, the keywords are mapped to the directory in the attribute repository. Specifically, if a synonym-extended keyword is a word in a directory in the attribute repository, the keyword is mapped to the directory node. If a synonym-extended keyword is an attribute word in the attribute repository, it is mapped to the first-level directory node. Alternatively, the synonym-extended keywords are all mapped to the first-level directory node in the attribute repository.

If the synonym-extended keywords have no matching directory in the attribute repository, no mapping is made.

In step s105, the network side searches the content of the directory for the keywords.

By using the directory for the keywords established in step s104, the network side searches the content of each sub-directory in the directory for the keywords.

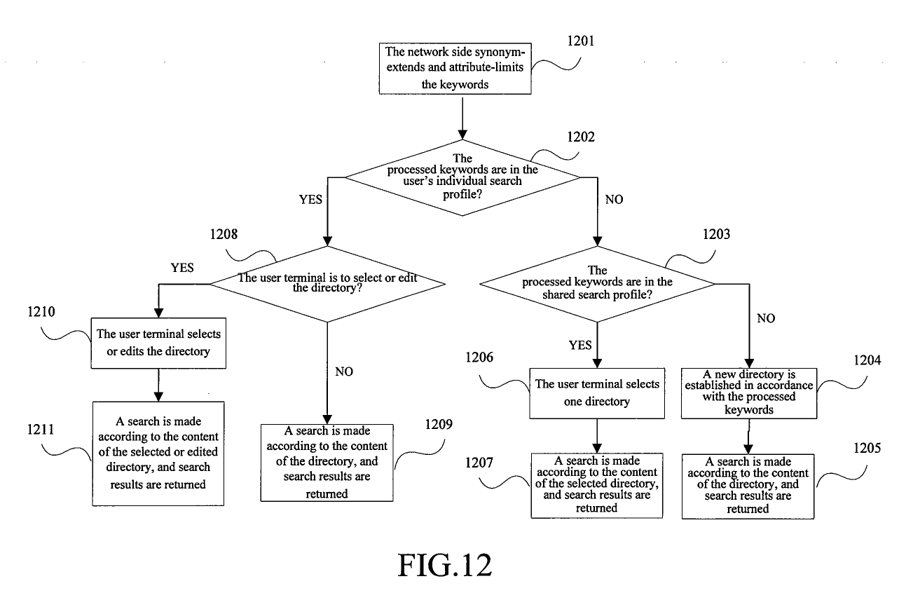

To better illustrate the method, the steps s105 and s106 in FIG. 1 are combined. The flow is as shown in FIG. 12 and includes the following steps.

In step 1201, the network side performs a synonym extension and an attribute limitation on the keywords.

In step 1202, the network side determines whether the processed keywords are in the user's individual search profile. If the processed keywords are not in the user's individual search profile, the flow proceeds with step 1203. If the processed keywords are in the user's individual search profile, the flow proceeds with step 1206.

In step 1203, the network side determines whether the processed keywords are in the shared search profile. If the processed keywords are not in the shared search profile, the flow proceeds with step 1204. If the processed keywords are in the shared search profile, the flow proceeds with step 1206.

In step 1204, a search is made in accordance with the processed keywords.

In step 1205, a directory is established in the shared search profile according to the search results, and the search results are displayed in accordance with the directory. The flow ends here.

In step 1206, if there are several directories containing the processed keywords, the user terminal may select one directory. This step is optional.

In step 1207, a search is made according to the content of the directory selected by the user terminal, and search results are returned. The flow ends here.

In step 1208, the user terminal determines whether to select or edit the directory. If the determination is negative, the flow proceeds with step 1209; if the determination is positive, the flow proceeds with step 1210.

In step 1209, search results are returned according to the content of the directory of the individual search profile at the user terminal. The flow ends here.

In step 1210, the user terminal selects or edits the directory.

In step 1211, a search is made according to the content of the directory selected or edited by the user terminal, and search results are returned. The flow ends here.

In step s106, the network side displays the search results to the user according to the directory for the keywords.

At this step, when the search results are displayed to the user, the search results may be displayed to the user in different topical categories only according to the directory for the keywords. Alternatively, the search results may be sorted with the weights for the directory calculated in step 206 shown in FIG. 2, and the sorted results are displayed to the user.

In the flow shown in FIG. 1, the network side updates the individual search profile of the user terminal according to the browse record for the search results by the user terminal in step 107, the update including updating the individual synonym repository and updating the individual attribute repository.

Updating the individual synonym repository of the user may include: modifying a synonym. The user may modify an uncertain synonym; the modification may also be made by deletion and addition of the synonym.

Updating the individual attribute repository of the user may include: extracting the attributes of the keywords from the search results, and mapping the extracted attributes to a directory in the attribute repository, to obtain new contents for the directory. Alternatively, the attribute repository may be updated in accordance with the operation records over the search results by the user.

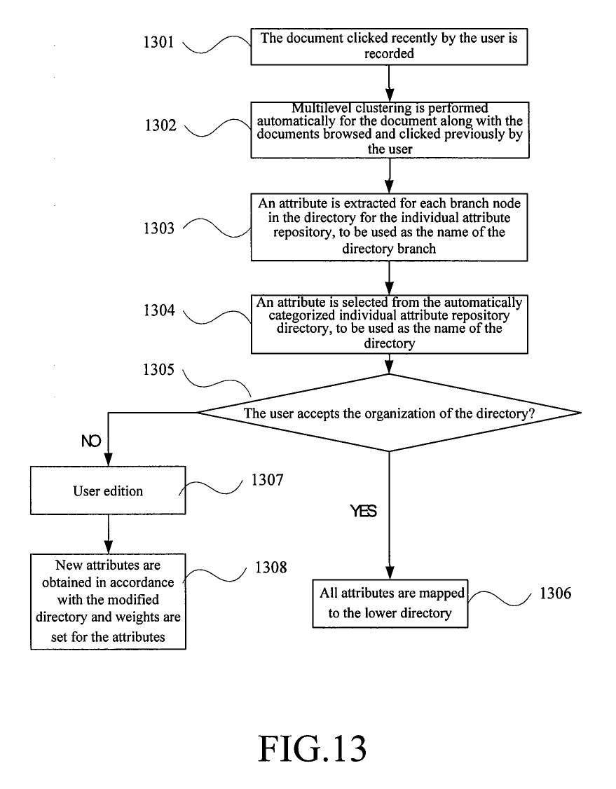

An embodiment for updating the individual attribute repository is as shown in FIG. 13, including the following steps.

In step 1301, the document clicked recently by the user is recorded.

In step 1302, a multilevel clustering is performed automatically for the document and the documents browsed and clicked by the user previously.

Alternatively, in this step, the user may delete a document browsed and clicked previously, or the system may automatically delete some obsolete documents or select to keep some important documents regularly. For example, the system may delete some documents under a directory unused for a long time, delete a document not well matched with the directory, or delete a document having a certain lifetime. Both may be combined. Alternatively, the statistics of the pervious keywords may be maintained, the currently clicked document may be used, the parameters may be updated, and re-clustering may be performed in accordance with the updated parameters.

In step 1303, an attribute is extracted for each branch node of a directory in the individual attribute repository, and is used as the name of the directory branch. The principle is minimum change, and the original name of the directory is used as much as possible.

In step 1304, the user selects an attribute from the automatically categorized individual attribute repository directory, to be used as the name of the directory.

In step 1305, a determination is made whether the user accepts the organization of the directory. If the determination is positive, the flow proceeds with step 1306; if the determination is negative, the flow proceeds with step 1307.

In step 1306, all attributes are mapped to the bottom of the directory branch in the individual attribute repository, to be taken as the attributes of the bottom directory branch. Weights are set for the attributes and the flow ends here.

In step 1307, the original structure of the directory may be selected or the directory may be modified by the user.

In step 1308, a new attribute may be obtained in accordance with the modified directory and a weight is set for the attribute.

In step 1308, the user stores some documents in the related directories manually. In accordance with the directories, the attributes generated from the documents are saved and the weights are set for the attributes. Alternatively, in accordance with the matching degree between document and directory, the documents are mapped to a most related lower directory. Then, the weight for each directory node may be set to a constant, or the weight is set in accordance with the position of the directory node in the directory, for example, as the directory node is closer to the bottom, the weight is set higher. Then, the attributes and the weights may be generated in accordance with the mapped document.

Moreover, the above two manners may be combined. After the directory is modified, (1), the user may save some documents in the directory manually, and the initial attributes and weights for the directory may be obtained through the categorization method according to the stored documents and directory; and (2), the system maps the remaining documents having not been stored in any directory manually to the directory based on the obtained attributes and weights, and then obtains the attributes and weights according to all documents.

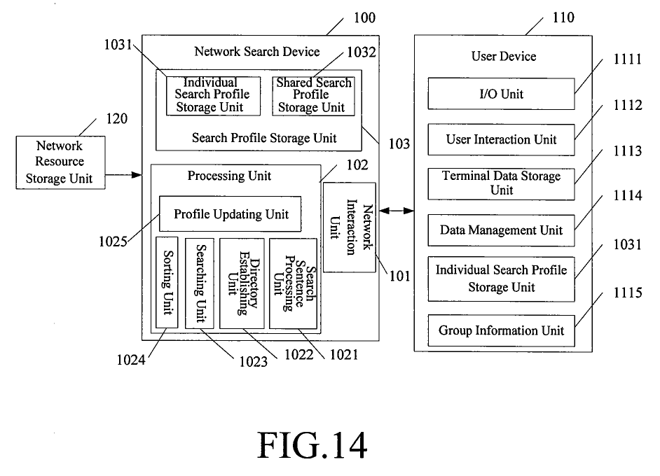

Detailed descriptions are made below to the network search system provided in an embodiment of the invention. As shown in FIG. 14, the system may include a network search device 100 and a user device 110.

The user device 110 is configured to send a search sentence to the network search device 100 and to receive the search results provided from the network search device 100.

The network search device 100 is configured to obtain a search sentence sent from the user device, to extract keywords from the search sentence, to establish a directory for the keywords in accordance with a search profile, to search in accordance with the directory for the keywords so as to obtain search results, and to provide the search results to the user device 110 in accordance with the directory for the keywords.

The system may further include a network resource storage unit 120, configured to store network resources.

The network search device 100 searches the network resource storage unit 120, to obtain search results.

The network resource storage unit 120 may be provided in the network search device 100.

The network search device 100 may include a network interaction unit 101, a processing unit 102, and a search profile storage unit 103.

The network interaction unit 101 is configured to obtain a search sentence sent from the user device 110 and send the search sentence to the processing unit 102, and to receive search results provided from the processing unit 102 and provide the search results to the user device 100.

The processing unit 102 is configured to receive the search sentence sent from the network interaction unit 101, to extract keywords from the search sentence, to establish a directory for the keywords in accordance with a search profile stored in the search profile storage unit 103, to search the network resource storage unit 120 in accordance with the directory for the keywords so as to obtain search results, and to provide the search results to the network interaction unit 101 according to the directory for the keywords.

The search profile storage unit 103 is configured to store the search profile.

The search profile storage unit 103 includes an individual search profile storage unit 1031 and a shared search profile storage unit 1032.

The individual search profile storage unit 1031 is configured to store the individual search profile.

The shared search profile storage unit 1032 is configured to store the shared search profile.

The processing unit 102 includes a search sentence processing unit 1021, a directory establishing unit 1022, a searching unit 1023 and a sorting unit 1024.

The search sentence processing unit 1021 is configured to extract keywords from a received search sentence, and to send the extracted keywords to the directory establishing unit 1022.

The directory establishing unit 1022 is configured to receive the keywords provided from the search sentence processing unit 1021, to obtain a search profile from the search profile storage unit 103, to obtain a directory for the keywords by using the search profile, and to provide the directory for the keywords to the searching unit 1023.

The searching unit 1023 is configured to search in the network resource storage unit 120 by using the directory for the keywords provided from the directory establishing unit 1022, and to provide the search results to the sorting unit 1024.

The sorting unit 1024 is configured to receive the search results provided from the searching unit 1023, to sort the search results according to the directory for the keywords established by the directory establishing unit 1022, and to provide the sorted search results to the network interaction unit 101.

The search profile storage unit 103 is further configured to store the directory for the keywords established by the directory establishing unit 1022.

The directory establishing unit 1022 is further configured to store the established directory for the keywords in the search profile storage unit 103.

The sorting unit 1024 may be further configured to obtain the directory for the keywords from the directory establishing unit 1022.

The processing unit 102 may further include a profile updating unit 1025, configured to update the search profile in the search profile storage unit 103 according to the user browse information provided from the network interaction unit 101.

The profile updating unit 1025 is configured to update the search profile in the search profile storage unit 103, including the individual search profile storage unit 1031 and the shared search profile storage unit 1032. The update includes addition, modification, combination and deletion of a synonym in the synonym repository, and addition, modification, combination and deletion of a directory and an attribute in the attribute repository.

Detailed descriptions are made below to the elements of the user device 110. The user device 110 may include an I/O unit 1111 and a user interaction unit 1112.

The I/O UNIT 1111 is configured to obtain a search sentence input by a user, to send the search sentence to the user interaction unit 1112, and to display search results provided by the user interaction unit 1112 to the user.

The user interaction unit 1112 is configured to send the search sentence from the I/O unit 1111 to the network search device 100, to receive the search results from the network search device 100, and to provide the search results to the I/O unit 1111.

The user device 110 may further include a terminal data storage unit 1113, configured to store the user browse information.

The user interaction unit 1112 is further configured to provide the user browse information stored in the terminal data storage unit to the network search device 100.

The user browse information may include information about the clicking and browsing for the query results by the user.

The user device 110 may further include a data management unit 1114, configured to manipulate the search profile in the network search device.

The manipulation of the search profile may include querying, adding, modifying, combining or deleting the search profile and its directory.

The user device 110 may further include a group information unit 1115, configured to manage information about a user terminal group to which the user device belongs, and to provide the shared profile and directory in the user terminal group to the data management unit 1114.

The data management unit 1114 may be further configured to manipulate the search profile according to information in the user group provided by the group information unit 1115.

Alternatively, the individual search profile storage unit 1031 in the network search device 100 may be provided in the user device 110.

If the individual search profile storage unit 1031 is provided in the user device 110, the individual search profile storage unit 1031 is configured to store the individual search profile of the user.

The data management unit 1114 is further configured to query and/or establish and/or update the individual search profile, and to provide the individual search profile of the individual search profile storage unit 1031 to the network search device 100 via the user interaction unit 1112.

It can be seen from the above technical solutions that, with the method, system and device provided in embodiments of the invention, a directory for keywords is established, a search is made according to the content of the directory for the keywords, and the search results are provided to the user according to the directory for the keywords. In this manner, the search results desired by the user are arranged by categorizing different topics according to the contents of the directory for the keywords, as compared with the prior arts in which the topics of all search results are mixed together. Therefore, with the method, system and device provided in embodiments of the invention, the search results desired by the user may be categorized according to different topics and provided so that the presentation of the search results is more straightforward and intelligible.

Preferably, with the method, system and device provided in embodiments of the invention, a keyword may be extended by using the synonym repository in the search profile so as to improve the search coverage, and the keyword may be limited by using the attribute repository in the search profile so as to improve the search accuracy.

Moreover, by establishing the individual search profile and the shared search profile, the user may change the content and the result of the individual search profile according to his personal requirements, so that the user may participate in the control of the search with the keywords. The network side may update the individual search profile and the shared search profile according to the webpage browse information of the user. Also, the user and the network side may control and improve the establishment of the directory for the keywords in accordance with the individual search profile and the shared search profile. Accordingly, the search requirements of the user may be satisfied better.

The invention has been described with reference to specific embodiments, which are not used to limit the scope of the invention. Those skilled in the art may make various changes without departing from the principle of the invention.

What is claimed is:

1. A network search method, comprising:
obtaining a search sentence from a user, extracting keywords from the search sentence, and establishing a directory for the keywords based on a pre-established search profile;
searching in accordance with contents of the directory for the keywords, to obtain search results; and
providing the search results to the user in accordance with the directory for the keywords.

2. The method according to claim 1, further comprising: establishing the search profile; and the search profile is established by establishing a synonym repository for extending a keyword and an attribute repository for limiting the keyword.

3. The method according to claim 2, wherein
the search profile comprises an individual search profile; and
the establishing the synonym repository of the individual search profile comprises:
adding a keyword to the synonym repository of the individual search profile, and
adding a synonym of the keyword, to obtain the synonym repository of the individual search profile.

4. The method according to claim 2, wherein
the search profile comprises a shared search profile; and
the establishing the synonym repository of the shared search profile comprises at least one of the following ways:
combining individual synonym repositories for all users to obtain the synonym repository of the shared search profile; and
adding the synonym of the keyword to the synonym repository of the shared search profile according to synonyms for the keyword recommended by the network side.

5. The method according to claim 2, wherein the establishing the attribute repository of the search profile comprises:
adding attributes for the keyword to the attribute repository, and
establishing a directory for the attributes based on relations between the attributes for the keyword, to obtain the attribute repository of the search profile.

6. The method according to claim 2, wherein before the directory for the keywords is established in accordance with the pre-established search profile or after the search results are provided to the user, the method further comprises: updating the search profile; and wherein
the updating the search profile comprises: adding and/or modifying and/or deleting automatically, by a user device, a synonym of the keyword or a directory branch for an attribute of the keyword in the search profile according to a system recommendation.

7. The method according to claim 2, wherein after the search results are provided to the user, the method further comprises: updating the search profile; and wherein
the updating the search profile comprises: adding and/or modifying and/or deleting, by the network side or a user device, a synonym of the keyword or a directory branch for an attribute of the keyword in the search profile based on information about the user's browse condition or the search results.

8. The method according to claim 7, wherein
the adding the synonym of the keyword in the search profile comprises:
setting an addition threshold; and
adding the synonym of the keyword to the search profile when the occurrence frequency of the synonym of the keyword is larger than the threshold;
and
the deleting the synonym of the keyword in the search profile comprises:
setting a deletion threshold; and
deleting the synonym of the keyword from the search profile when the occurrence frequency of the synonym of the keyword is smaller than the threshold.

9. The method according to claim 2, wherein the extracting keywords from the search sentence and establishing the directory for the keywords based on the pre-established search profile comprises:
segmenting the search sentence and extracting keywords from the search sentence;
performing a synonym extension and/or an attribute limitation on the keywords with the search profile;
organizing the synonym-extended and/or attribute-limited keywords in a logical OR expression;
obtaining a sub-directory for each sentence in the logical OR expression in the attribute repository; and
forming the directory for the keywords with all sub-directories;
and the searching in accordance with the contents of the directory for the keywords comprises:
searching in accordance with contents of each sub-directory in the directory for the keywords.

10. The method according to claim 1, wherein the establishing the directory for the keywords comprises:
selecting a user terminal group to which the user's terminal belongs; and
establishing the directory for the keywords based on contents of a shared repository for the user terminal group.

11. The method according to claim 1, wherein the providing the search results to the user according to the directory for the keywords comprises:
performing a topical categorization on the search results according to sub-directories indicating different topics in the directory for the keywords, and providing the categorized results to the user respectively; and/or
weighting and sorting sub-directories for the keywords, and providing the search results to the user according to the sorting results.

12. A network search device, comprising a network interaction unit, a processing unit and a search profile storage unit, wherein:
the network interaction unit is configured to receive a search sentence and send the search sentence to the processing unit, and to receive search results provided from the processing unit and send the search results;
the processing unit is configured to receive the search sentence sent from the network interaction unit, to extract keywords from the search sentence, to establish a directory for the keywords based on a search profile stored in the search profile storage unit, to search in accordance with contents of the directory for the keywords so as to obtain the search results, and to provide the search results to the network interaction unit in accordance with the directory for the keywords; and
the search profile storage unit is configured to store the search profile.

13. The network search device according to claim 12, wherein the search profile storage unit comprises:
an individual search profile storage unit, configured to store an individual search profile; and
a shared search profile storage unit, configured to store a shared search profile.

14. The network search device according to claim 12, wherein the processing unit comprise a search sentence processing unit, a directory establishing unit, a searching unit and a sorting unit; and wherein:
the search sentence processing unit is configured to extract the keywords from the received search sentence, and to send the extracted keywords to the directory establishing unit;
the directory establishing unit is configured to receive the keywords provided from the search sentence processing unit, to obtain the search profile from the search profile storage unit, to obtain the directory for the keywords by using the search profile, and to provide the directory for the keywords to the searching unit,
the searching unit is configured to search in the network resource storage unit by using the directory for the keywords provided from the directory establishing unit, and to provide the search results to the sorting unit; and
the sorting unit is configured to receive the search results provided from the searching unit, to sort the search results according to the directory for the keywords established by the directory establishing unit, and to provide the sorted search results to the network interaction unit.

15. The network search device according to claim 14, wherein
the search profile storage unit is further configured to store the directory for the keywords established by the directory establishing unit;
the directory establishing unit is further configured to store the established directory for the keywords in the search profile storage unit; and
the sorting unit is further configured to obtain the directory for the keywords from the directory establishing unit.

16. The network search device according to claim 14, wherein the processing unit further comprises:
a profile updating unit, configured to update the search profile in the search profile storage unit based on the user's browse information provided from the network interaction unit.

17. A user device, comprising an I/O unit, a user interaction unit and a terminal data storage unit, wherein:
the I/O unit is configured to obtain a search sentence input by a user, to send the search sentence to the user interaction unit, and to display search results provided by the user interaction unit to the user;
the user interaction unit is configured to send the search sentence from the I/O unit to a network search device, to receive the search results from the network search device according to the user's browse information, to provide the search results to the I/O unit, and to provide the user's browse information stored in the terminal data storage unit to the network search device; and
the terminal data storage unit is configured to store the user's browse information.

18. The user device according to claim 17, further comprising:
a data management unit, configured to query and/or establish and/or update a search profile in the network search device.

19. The user device according to claim 18, further comprising:
a group information unit, configured to manage information about a user terminal group to which the user device belongs, and to provide contents of a shared profile in the user terminal group to the data management unit;
wherein the data management unit is configured to query and/or establish and/or update a search profile in the network search device based on the contents of the shared profile in the user terminal group provided from the group information unit.

20. The user device according to claim 18, further comprising:
an individual search profile storage unit, configured to store an individual search profile for the user;
wherein the data management unit is further configured to query and/or establish and/or update the individual search profile, and to provide the individual search profile in the individual search profile storage unit to the network search device via the user interaction unit.
